(19) United States
(12) Patent Application Publication
(10) Pub. No.: US 2008/0210500 A1
(43) Pub. Date: Sep. 4, 2008

(54) Hydraulic Regenerative Braking System For a Vehicle

(76) Inventor: Frank H. Walker, Grand Blanc, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/913,971

(22) PCT Filed: May 11, 2006
(86) PCT No.: PCT/US2006/018236

§ 371 Date: Nov. 9, 2007

Related U.S. Application Data
(60) Provisional application No. 60/679,549, filed on May 11, 2005.
(60) Provisional application No. 60/684,711, filed on May 26, 2005.
(60) Provisional application No. 60/727,227, filed on Oct. 17, 2005.
(60) Provisional application No. 60/751,467, filed on Dec. 19, 2005.
(60) Provisional application No. 60/754,710, filed on Dec. 30, 2005.
(60) Provisional application No. 60/760,048, filed on Jan. 19, 2006.

(51) Int. Cl. B60T 11/12; G06F 19/00

(52) U.S. Cl. 188/151 R; 701/70

(57) ABSTRACT

One embodiment of a hydraulic regenerative braking system for a vehicle having at least one drive wheel includes first (24) and second (32) hydraulic machines operable as pumps or motors. One of the hydraulic machines operates in conjunction with the vehicle drive wheels, while the other hydraulic machine operates in conjunction with a flywheel arrangement (28) to store and receive energy. The hydraulic machines are connected to each other such that when one is operating as a pump, it provides fluid to the other to operate that machine as a motor. A control system is provided to receive inputs related to the operation of the vehicle, and to control the fluid flow through the hydraulic machines.

### CROSS-REFERENCE TO RELATED APPLICATIONS

This application claims the benefit of U.S. Provisional Application Ser. No. 60/679,549, filed May 11, 2005; U.S. Provisional Application Ser. No. 60/684,711, filed May 26, 2005; U.S. Provisional Application Ser. No. 60/727,227, filed Oct. 17, 2005; U.S. Provisional Application Ser. No. 60/751,467, filed Dec. 19, 2005; U.S. Provisional Application Ser. No. 60/754,710, filed Dec. 30, 2005; and U.S. Provisional Application Ser. No. 60/760,048, filed Jan. 19, 2006, each of which is hereby incorporated herein by reference.

### BACKGROUND OF THE INVENTION

1. Field of the Invention

The present invention relates to a hydraulic regenerative braking system for a vehicle.

2. Background Art

It is well known that hydraulic regenerative braking systems promise improved efficiency over electric regenerative systems incorporating a battery. Conventional hydraulic regeneration involves using a pump connected in the vehicle drivetrain as a retarding device, and then storing the resulting high pressure fluid in an accumulator. On subsequent vehicle acceleration, the high pressure fluid from the accumulator is routed to a hydraulic motor and the stored energy is recovered in the form of mechanical work that drives the vehicle forward. A low pressure accumulator acts as a reservoir to make up for fluid volume variations within the high pressure accumulator, and also provides a charge pressure to the inlet side of the pump. One such system is described in U.S. Patent Application Publication No. 2006/0055238, entitled “Hydraulic Regenerative Braking System For A Vehicle,” filed on Dec. 16, 2003, which is hereby incorporated herein by reference.

The high and low pressure accumulators of conventional hydraulic regenerative systems may occupy an undesirable amount of space in a vehicle, making an alternative energy storage system desirable. Even though small accumulators may be necessary in a hydraulic regenerative system, it may be possible to significantly reduce their size if the primary energy storage system does not require a large volume of fluid to be stored under pressure. Therefore, a need exists for a hydraulic regenerative braking system for a vehicle that provides an energy storage system, and facilitates the use of the stored energy, without requiring a large volume of fluid to be stored under pressure.

### SUMMARY OF THE INVENTION

Accordingly, the present invention provides a hydraulic regenerative braking system for a vehicle that conserves space by using one or more flywheel arrangements configured to store energy and provide access to the stored energy.

The invention also provides a hydraulic regenerative braking system that includes a hydraulic machine operable as a pump or a motor connected to a flywheel arrangement to facilitate a transfer of energy to and from the flywheel arrangement. In one embodiment, the hydraulic machine is a micro radial piston pump/motor which can operate at speeds on the order of 60,000 revolutions per minute (RPM) to 100,000 RPM. This can be accomplished by using two clusters of cylinders with approximately six to eight cylinders per cluster, and using only two lobes on a cam, which is disposed inboard from the pistons. In one embodiment, a valve plate rotates synchronously with a two-lobe cam. The rotating valve plate is indexable by 90° to allow internal switching from a pumping function to a motoring function. This indexing can be accomplished by changing the axial position of the driving shaft relative to the body of the pump/motor.

The piston cylinders, which are disposed in a cylinder block, are alternately connected between a high pressure fluid port and a low pressure fluid port. The crossover from high pressure to low pressure may occur when the pistons are at top dead center (TDC) and bottom dead center (BDC), or they may occur at intermediate points. If the pump/motor is configured such that the crossover always occurs at TDC and BDC, the pump/motor will be of fixed displacement. In such a case, a hydraulic transformer may be included in the system to vary the output of the pump/motor. Alternatively, the pump/motor can be configured such that the crossover between high pressure and low pressure occurs at various positions in the piston stroke, allowing for the pump/motor to be a variable displacement device.

In order to capture the braking energy of the vehicle, and to provide torque to aid in the propulsion of the vehicle, one or more pump/motors can be disposed on a shaft of the vehicle powertrain, such as a driveshaft or axle. This pump/motor is connected to the pump/motor of the flywheel arrangement, such that energy can be transferred between the vehicle drive wheels and the flywheel. For example, during vehicle braking, the pump/motor of the vehicle drivetrain acts as a pump, helping to slow the vehicle, while pumping fluid to the pump/motor of the flywheel arrangement, causing it to operate as a motor. As the pump/motor of the flywheel operates as a motor, it spins the flywheel, thereby storing the energy captured from the vehicle braking. Conversely, when the hydraulic system is operated to output torque to drive the vehicle, the pump/motor at the flywheel operates as a pump driven by the flywheel, and outputs hydraulic fluid to the pump/motor of the vehicle drivetrain, which is now operating as a motor to output torque to power the vehicle.

Either or both of the pump/motor associated with the flywheel, and the pump/motor associated with the vehicle drivetrain, can be variable displacement machines. Conversely, both can be fixed displacement machines, wherein a hydraulic transformer is provided in the system to modulate the fluid flow. The pump/motor associated with the flywheel will typically spin much faster than the pump/motor associated with the vehicle powertrain. Therefore, the pump/motor of the flywheel will often be configured such that the cam and an associated valve plate rotate, while a port housing containing the fluid ports, and a cylinder block containing the piston cylinders, remain stationary. The pump/motor associated with the vehicle drivetrain may also have this configuration. Conversely, the pump/motor of the vehicle drivetrain may be configured with an outer housing outside of the cylinder block, such that the cylinder block rotates, while the outer housing, port housing, cam and associated valve plate remain generally stationary. Of course, the valve plate and cam will move relative to each other in order to change the operation of the hydraulic machine from a pump to a motor, or vice versa.

Like the pump/motors, a hydraulic transformer used in a hydraulic regenerative braking system in accordance with the present invention can be a radial piston device, rather than an axial piston device, which may use a bent axis or wobble plate. The radial piston transformer can provide a theoretically uniform flow velocity, something that may not be possible with axial piston devices which produce an almost signwave motion. In one embodiment, the hydraulic transformer used in the regenerative braking system of the present invention has a step up/step down ratio of 5:1. Neglecting friction and leakage, in the step up mode, the input could be, for example, 5 gallons per minute (GPM) at 1000 pounds per square inch (psi). Output for this device could be 1 GPM at 5000 psi, with 4 GPM at 0 psi exhausted to a sump tank. Conversely, in the step down mode, the input could be 1 GPM at 5000 psi with 4 GPM at 0 psi being received from the tank. In this case, output would be 5 GPM at 1000 psi. To accomplish this most efficiently and with the least flow disturbance, port durations are approximately in proportion to the relative flow demands. This means that the time during which certain cylinders are exposed to either the high or low pressure fluid ports would be directly dependent on the demand of the fluid flow. The fluid flow is the integral of velocity times time, so a plot of flow versus time generates a curve, and the area under this curve equals the amount of flow for each of the three pressures—i.e., the input pressure, the output pressure, and the tank pressure.

In one embodiment, such a variable ratio transformer may be configured with 14 radial pistons, having two sets of seven pistons disposed adjacent each other. A three-lobe cam is provided to actuate the pistons, and there are three port holes (high, low, tank) in the associated valve plate for each lobe. If an event is defined as changing the port to which a cylinder is connected, this example would provide 14×9, or 126 events per revolution. If the events are equally spaced, an event would occur in every 2.857 degrees of rotation.

Rotating the valve plate relative to the cam quickly changes the flow quantity such that the 5:1 transformer described above can operate at pressure ratios from approximately 3:1 to 8:1 with a minimum of flow disturbances. Of course there are many other combinations of pressure ratios, numbers of cylinders, numbers of cam lobes, and spacing of cam lobes, that can be used to provide transformers having other operating characteristics.

Some radial piston pump/motors, and radial piston transformers, may experience a low torque at startup caused by an absence of hydraulic fluid to lubricate the interface between the piston and the cam follower. For example, the cam follower, which may be a journal or other rolling element, may be directly in contact with the piston head when the hydraulic machine is started. In order to overcome this problem, embodiments of the present invention use a two-stage piston, which includes a small piston disposed inside the piston head of the primary piston. The small piston may be disposed in a cylinder that communicates with the interface between the cam follower and the primary piston head. The small piston can be configured such that it has one diameter facing the primary piston cylinder, and a smaller diameter facing the interface between the cam follower and the primary piston head. In this way, as hydraulic fluid enters the primary piston cylinder, it acts on the larger diameter of the small piston with a downward force. As the small piston moves downward, the smaller diameter portion below pushes hydraulic fluid into the interface between the cam follower and the primary piston head, causing the primary piston head to separate from the cam follower. This provides lubrication between the moving parts, increasing the torque of the hydraulic machine on startup.

As noted above, the hydraulic pump/motor associated with the flywheel may rotate at very high speeds. Because there is fluid moving between the rotating parts, it is desirable to provide seals between the rotating parts to prevent leakage of the hydraulic fluid. Seal rings and lip seals may be adequate at lower speeds and/or lower pressures, but may have high parasitic power losses and poor durability when there is a combination of high speed and high pressure. To address this issue, embodiments of the present invention include a helical grooved labyrinth seal along with a close tolerance journal bearing. The labyrinth seal includes a series of close clearance lands, each followed by a groove to provide a sharply increased volume. As fluid flows through a labyrinth passage, its flow velocity alternately increases and decreases, and each transition acts as a sharp edged orifice to impede the flow. For example, the equation for velocity of efflux is:

V=[(2)(g)(h)]^{1/2}(K), where (g) is the acceleration due to gravity, (h) is the fluid height, and (K) is approximately equal to 0.65 for a sharp edged orifice.
Incorporating a series of sharp edged orifices as in a labyrinth seal, a decrease in flow approaching 0.65ⁿ can be accomplished, with n being the number of grooves in the labyrinth. Therefore, by adding length to the journal, additional lands and grooves can be provided, and leakage decreased rapidly.

As a first approximation, it can be considered that fluid between a rotating shaft and a close fitting stationary housing, or between a stationary shaft and a close fitting rotating housing, rotates at approximately half the speed of the rotating member. Thus, a helical groove in either or both of the members will result in axial movement of the fluid relative to the rotating or stationary member. If, for example, a shaft as viewed from one end is rotating clockwise inside a stationary journal bearing in a housing, then fluid between the shaft and housing would be turning clockwise at some lesser speed relative to the stationary housing, but counterclockwise relative to the higher speed rotating shaft. Therefore, lefthand helical grooves in the rotating shaft would pump fluid away from the viewer of this example, while righthand helical grooves in the stationary internal bearing journal would do the same. Pumping action of fluid in rotating helical grooves or rotating fluid in the mating stationary grooves can be made to counteract the axial leakage within the labyrinth seal.

Another feature of the hydraulic system of the present invention is that it can be configured to cooperate with an electric machine—e.g., a generator/motor—to further store or receive energy from the flywheel. Embodiments of the present invention may use a small electric machine that can be operated as a motor to rotate the flywheel when the vehicle is not in use. In addition, energy from the flywheel can be used by the electric machine when it operates as a generator, thereby outputting energy to an electrical grid. For example, the power level for the hydraulic system cooperating with the vehicle drivetrain may be on the order of 10-50 times the power level for the electric machine. The advantage of combining energy from an electrical grid with hydraulic systems is that it is possible to charge the onboard system—i.e., rotate the flywheel—with low cost surplus energy from the grid during off peak times. Moreover, if there are enough such users, it may be cost effective to transfer some of the excess energy stored by the flywheel back to the grid during peak electrical power demands. Energy from the flywheel could also be used as an emergency back up electrical power supply for a short time during power outages.

Utilizing a small electric motor as described above, can provide the flywheel with enough energy to drive the vehicle for an extended period of time, with the hydraulic pump/motors interfacing with the vehicle drivetrain to operate the vehicle at highway speeds. After the stored energy received from the electric motor has been depleted, it is possible for a control system to sense the condition, and to command recharging of the flywheel. This can occur not only while the vehicle is braking, but also while the vehicle is driving on the highway. Operating a vehicle at highway speeds typically results in operation of the engine somewhere between 10% and 30% of full load. This is a very inefficient operating mode. Typically, internal combustion engines operate most efficiently between 60% and 90% of full power.

To address this low efficiency operation of the engine, which is prevalent during a major portion of current vehicle operation, the present invention contemplates switching to a “charge mode,” wherein the engine power is increased and the excess energy is used to charge the flywheel while the vehicle is being driven. When the control system senses that the flywheel is sufficiently charged, the engine is turned off, and the stored energy from the flywheel continues to propel the vehicle. All this can occur with little or no command or awareness from the driver. A separate small hydraulic or electric motor operating from the same stored energy can be used to operate the accessories, such as air conditioning, alternator, or power steering, as required. In order to provide an efficient match between the speed of the flywheel—e.g., 3,300-11,000 RPM—and the speed of the vehicle—e.g., 0-80 mph—the hydraulic pump/motors can be sized for some nominal speed ratio. There are at least two methods for varying the flow rate provided to the flywheel hydraulic unit and the vehicle drivetrain hydraulic unit.

In one embodiment, a continuously variable external flow rate is made possible by indexing a valve plate in a port housing relative to the cam in small increments. This means that the pressure switch from high pressure to low pressure in the piston cylinders can occur anywhere along the piston stroke, instead of occurring only at TDC and BDC. This allows for fine tuning of the torque provided when the hydraulic machine is operating as a motor, or the pump torque when the hydraulic machine is operating in a braking mode. The cam indexing is controlled by a mode piston, the same control that indexes the valve plate to switch the machine between a pump and a motor. Special cam lobe and valve plate port spacing can be used to ensure that all the switching events do not occur simultaneously. The continuously variable operation of hydraulic machines is described in detail in International Patent Application PCT/US2005/045825, filed Dec. 16, 2005, which is hereby incorporated herein by reference.

In other embodiments of the present invention, either or both of the flywheel machine and the vehicle drivetrain machine are configured as three speed units, which means that there are three distinct flow rates. This may be accomplished, for example, by using a four-lobe cam with eight corresponding connecting ports. Two opposite lobes correspond with one pair of high pressure ports, and the other two lobes correspond with a second pair of high pressure ports. One opposite pair of lobes has a full piston stroke, and the other pair of opposite lobes has a shallow valley and provides, for example, 61.8% of the piston stroke. Interspersed between the four high pressure ports are the four remaining ports, which are continuously connected to the low pressure feed. A pair of controlling spool/poppet valves can independently switch the first pairs of ports from high pressure to low pressure.

When the controlled port is switched to high pressure, the radial piston is connected alternately to a high pressure line and a low pressure line at the end of each stroke. If operating as a pump, the outstroke is at high pressure and the instroke is at low pressure. Conversely, when the machine is operating as a motor, the outstroke is at low pressure and the instroke is at high pressure. When it is desired to cut out a pair of cam lobes to decrease the flow when the machine is operating as a pump, or increase the speed if the machine is operating as a motor, the corresponding spool/poppet valve switches these high pressure ports to low pressure. In this case, the piston continues to stroke, but with a continuous connection to the low pressure port, resulting in no net external flow for these strokes. If the full stroke pistons are disabled, the unit operates with, for example, 38.2% displacement. If the partial stroke pistons are disabled, the unit operates with, for example, 61.8% displacement. With three discrete and approximately evenly spaced flow ranges at the flywheel hydraulic unit and three discrete and approximately evenly spaced flow ranges at the vehicle drive unit, there are nine possible speed ratios provided. One can make the analogy to a nine-speed bicycle having three sprockets at the pedal/crank, and three sprockets at the wheel.

The two methods of flow modulation described above are complementary with each other, and the discrete changes, resulting from switching the number of cam lobes during operation, can reduce flow interruptions caused by the continuous modulation provided by indexing the valve plate relative to the cam. Adding the valve plate indexing not only helps to smooth the incremental steps, but also extends both ends of the displacement ratio for the hydraulic machines.

The interaction of the two methods of flow modulation helps to provide a hydrostatic connectivity between the two large masses of the flywheel and the vehicle, as both undergo speed changes. The speed of the flywheel changes gradually, while the vehicle speed can change rapidly. Pressure relief valves at both ends of the hydraulic circuit can provide for any mismatch between the commanded ratio and the actual ratio, and a flow sensor in the pressure relief circuit can become a part of a feedback control system. To add elasticity to the system, and to help it respond to these speed changes, spring or gas accumulators can be added in the high pressure and low pressure lines. Also, the fluid lines, whether hoses or steel pipes, can be fabricated with an elastic liner to provide elasticity to the system.

Certain embodiments of flywheel arrangements used with the present invention can include two counter-rotating flywheels, each consisting of a hub, a main ring, and spokes to connect the ring to the hub. In one design, the two counter-rotating flywheels may be disposed in an over-under relationship on a vertical axis. A containment ring, such as a stationary split containment ring, can be disposed outside the rotating flywheel rings to provide a barrier between the flywheels and the external environment. The flywheels in the containment ring can both be disposed within a containment housing, which can be evacuated to a high vacuum to allow the flywheels to rotate freely with minimum air drag. The support system for the flywheels can include a planet carrier that sandwiches between two sections of the containment ring, and also separates the two flywheels. The spokes used on the flywheels can be provided with a brittle attachment which acts as a fuse in case of a vehicle accident greater than a specified magnitude.

To support the mass of the flywheels, low friction bearings, such as ceramic ball bearings or magnetic bearings, can be attached to a member of the housing immediately below the respective flywheel. The upper flywheel bearing can be supported by a center support plate, which also supports the planetary gear set. The lower flywheel bearing can be supported on the lower containment housing, with both upper and lower bearings being angular contact bearings capable of both radial and thrust loading. In order to reduce the load on the support bearings, electromagnets can be provided above each flywheel to carry up to 95% of the thrust load caused by the weight of the flywheel discs. This allows the use of a light-duty low friction ball bearing, which can help to keep down the overall cost of the system, while still providing minimum friction drag.

The planetary gear set described above can include a stationary carrier supported by a center plate, a plurality of bevel pinions supported on pins connected to the carrier, high speed bearings which allow the pinions to rotate on the pins, and two facing bevel ring gears which mesh with the pinions. Needle or other thrust bearings which support the bevel ring gears and contain the separating forces of the bevel gears as they mesh with the pinions, can also be used. Embodiments of the invention also include a pair of clutches remotely engageable and disengageable by a magnetic, pneumatic, hydraulic, mechanical, or other type of force which can be commanded by a controller. In the case of a system that includes an electric machine, such as described above, the electric machine can be attached through a center shaft to one of the bevel ring gears, and connected to one flywheel through one of the clutches. The higher power, high speed hydraulic pump/motor can be attached to the opposite bevel ring gear through a center shaft, and connected to the opposite flywheel hub through the second clutch.

Each face of the counter-rotating flywheel disc is specifically shaped such that contact will occur first at an inner diameter of the ring, and energy dissipation will begin. Matching steps can be placed on the contacting faces to help to ensure that the discs remain coaxial during such a coast down. In a vehicle crash, by allowing the first contact of the two discs to be at a controlled location, for example, specific friction faces near the inside diameter, the outer portions of the flywheel discs initially act as containment rings to absorb the first wave of energy being dissipated.

In embodiments of the hydraulic machines described above, high pressure fluid may enter the machine through a port housing, thereby imparting an axial load on at least a portion of the machine. In order to balance the force caused by the high pressure fluid, a large tapered roller bearing can be used. Such a solution has some disadvantages, however, in that such bearings tend to be expensive and occupy a large amount of space, as well as incurring parasitic losses associated with the rolling friction of high loads. As an alternative to using the large tapered roller bearing, embodiments of the present invention add a pressure balance area on the cylinder block on the opposite face from the direction of the fluid load. High pressure fluid is fed to a floating piston, such that the majority of the thrust load can be balanced hydraulically, and only a small portion of the thrust load transmitted to a lighter duty roller, ball, or journal bearing.

The balance piston described above is configured such that the area separating the piston face from the cylinder block is slightly larger than the area applying the piston. An orifice or restricted flow passage in the piston causes a pressure drop through the piston such that the pressure drop is proportional to the square of the flow velocity through the passage. This allows the balance piston to find a position such that the feed pressure times the applied area equals the separating area times the reduced pressure. The balance piston position is self-regulating. If leakage increases, the separating pressure drops, and the piston moves to decrease the leakage. Conversely, if leakage decreases, the separating pressure increases, and the piston moves to increase the leakage. In summary, the balance force on the cylinder block face is equal to the feed pressure times the applied area of the balance piston. The design of the flow restrictor is adjusted to minimize the loss due to high pressure fluid leakage while maintaining a film of fluid between the rotating cylinder block and the stationary balance piston.

If desired, a second balance piston can be added to balance the cylinder block force caused by the incoming fluid through the low pressure port. Alternatively, the high pressure balance piston area could be increased slightly to compensate for a minimum force exerted by the low pressure ports. Because the forces caused by the low pressure ports are low, on the order of 10% or less of the high pressure forces, it will often be more practical to increase the high pressure balance area slightly, rather than adding a second balance piston.

### BRIEF DESCRIPTION OF THE DRAWINGS

FIG. 1 is a partially schematic representation of a vehicle and a hydraulic regenerative braking system in accordance with one embodiment of the present invention;

FIG. 2 is a side view of the vehicle shown in FIG. 1;

FIG. 3 is a partially schematic view of a vehicle and a hydraulic regenerative braking system in accordance with another embodiment of the present invention;

FIG. 4 is a side view of the vehicle shown in FIG. 3;

FIG. 5 is a cross-sectional view of a flywheel arrangement used in the hydraulic regenerative braking system shown in FIG. 3;

FIGS. 6A and 6B are sectional views of a hydraulic pump/motor used in the hydraulic regenerative braking system shown in FIG. 3;

FIG. 6C is a detailed view of a balance piston arrangement as part of the hydraulic machine shown in FIG. 6B;

FIGS. 7A and 7B are detailed views of components of the hydraulic machine shown in FIGS. 6A and 6B;

FIGS. 8A and 8B are sectional views of a hydraulic transformer used in the hydraulic regenerative braking system shown in FIG. 1;

FIG. 9 is a detailed view of components of the hydraulic transformer shown in FIGS. 8A and 8B;

FIGS. 10A and 10B are front and side views of a dual piston configuration that can be used with the hydraulic machines and hydraulic transformer used in a hydraulic regenerative braking system in accordance with the present invention; and

FIGS. 11A and 11B illustrate a labyrinth seal used with a high speed pump/motor that is configured for use in a hydraulic regenerative braking system of the present invention.

### DETAILED DESCRIPTION OF THE PREFERRED EMBODIMENT(S)

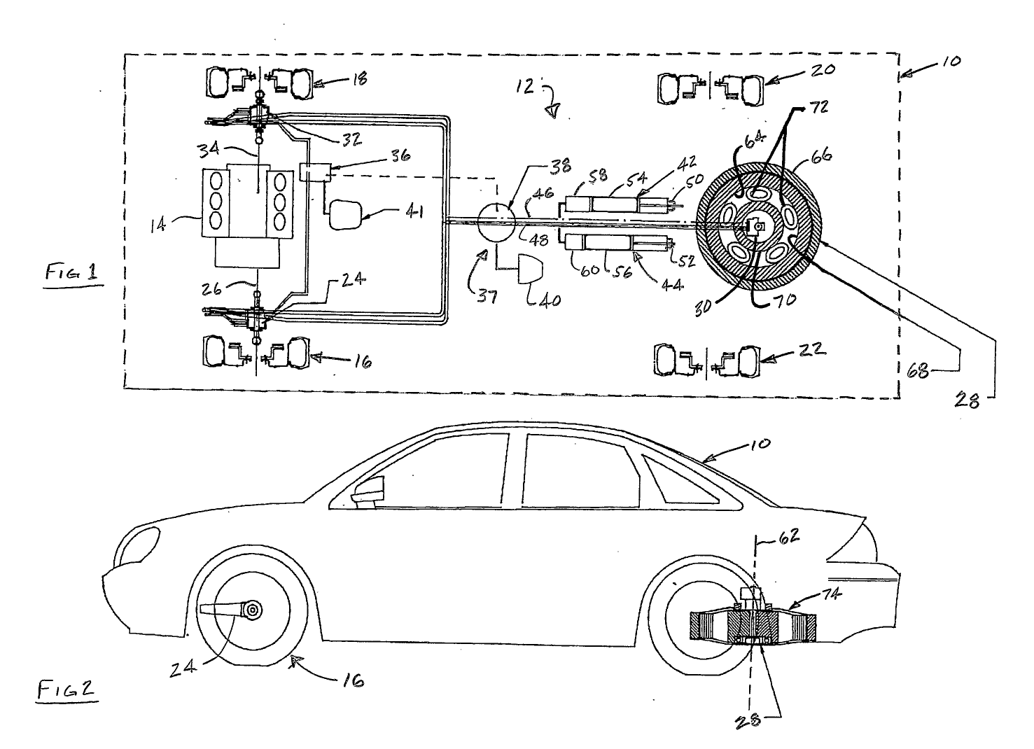

FIG. 1 shows a vehicle 10 including a hydraulic regenerative braking system 12 in accordance with one embodiment of the present invention. The vehicle 10 also includes an engine 14, and four wheels 16, 18, 20, 22, two of which, the wheels 16, 18, are drive wheels. The regenerative braking system 12 includes a first hydraulic machine, or pump/motor 24. The pump/motor 24 is connected to a shaft, which in the embodiment shown in FIG. 1, is a front axle 26 of the vehicle 10. As explained more fully below, the pump/motor 24 is configured to act as a motor to provide torque to the drive wheel 16, and to capture energy while the vehicle 10 is braking, and provide this energy to a flywheel arrangement 28 in the rear of the vehicle 10.

A second hydraulic machine, or pump/motor 30, is operatively connected to the flywheel arrangement 28, and is configured to receive fluid from the first pump/motor 24 to operate as a motor to provide torque to the flywheel arrangement 28. The second pump/motor 30 is also configured to operate as a pump, driven by energy received from the flywheel arrangement 28 to pump fluid to the first pump/motor 24 to facilitate operation of the first pump/motor 24 as a motor. As shown in FIG. 1, a third hydraulic machine or pump/motor 32 is connected to a front axle 34, and operates in conjunction with the drive wheel 18, similar to the operation of the pump/motor 24 with the drive wheel 16. Although two separate pump/motors 24, 32 are used in the embodiment shown in FIG. 1, a single pump/motor could be used to provide torque and receive energy from more than one drive wheel. For example, a single pump/motor can be mounted on a vehicle driveshaft as an alternative to placing one or more pump/motors on an axle.

The regenerative braking system 12 also includes a control system, shown in FIG. 1 as a control module 36. The control module 36 is configured to receive inputs related to the operation of the vehicle 10, and uses these inputs to control operation of the pump/motors 24, 30, 32. Such inputs may include driver initiated acceleration requests and braking requests, which may be input directly into the control module 36, or may be input from another controller, such as a vehicle system controller (not shown). In addition to electronic inputs, the control module 36 may also receive a number of hydraulic inputs (removed in FIG. 1 for clarity) to detect the various fluid pressures in the system 12, and to help control operation of the pump/motors 24, 30, 32. In addition to controlling operation of the pump/motors 24, 30, 32, the control module 36 also controls operation of a hydraulic transformer arrangement 37, which includes a hydraulic transformer 38.

The transformer 38 is a variable ratio transformer that is configured to modify the pressure, flow rate, or a combination thereof, of fluid flowing through it, and to or from the pump/motors 24, 30, 32. Including the transformer 38 in the regenerative braking system 12 allows the pump/motors 24, 30, 32 to be configured as fixed displacement machines, which can reduce their size and weight as compared to variable displacement machines. The transformer arrangement 37 also includes a tank 40 which can receive fluid from, or supply fluid to, the transformer 38, as it modifies the fluid flow to and from the various pump/motors 24, 30, 32.

Also shown in FIG. 1 is a small low pressure accumulator 41, which is attached to the control module 36. Although the input line or lines are not shown in FIG. 1, the accumulator 41 can be configured to receive fluid from various parts of the system 12, as a result of, for example, fluid leakage. Two other accumulators 42, 44 are also shown in FIG. 1, respectively attached to a high pressure fluid line 46, and a low pressure fluid line 48. In the embodiment shown in FIG. 1, each of the accumulators 42, 44 respectively include servo motors 50, 52, a nitrogen charged bladder 54, 56, and a fluid chamber 58, 60.

The accumulators 42, 44 add compliance to the hydraulic system 12, thereby allowing fluid to be temporarily stored in, or retrieved from, the fluid chambers 58, 60. This is useful in a hydraulic system, such as the regenerative braking system 12, in that both the vehicle 10, and the flywheel arrangement 28, have a relatively large mass, and change velocity only gradually compared to changes in operation of the pump/motors 24, 30, 32. Because the hydraulic fluid used in the system 12 will be generally incompressible, the accumulators 42, 44 provide a location for the fluid to migrate if the inertia of the vehicle 10 and/or the flywheel arrangement 28 is too great for the pump/motors 24, 30, 32 to immediately overcome.

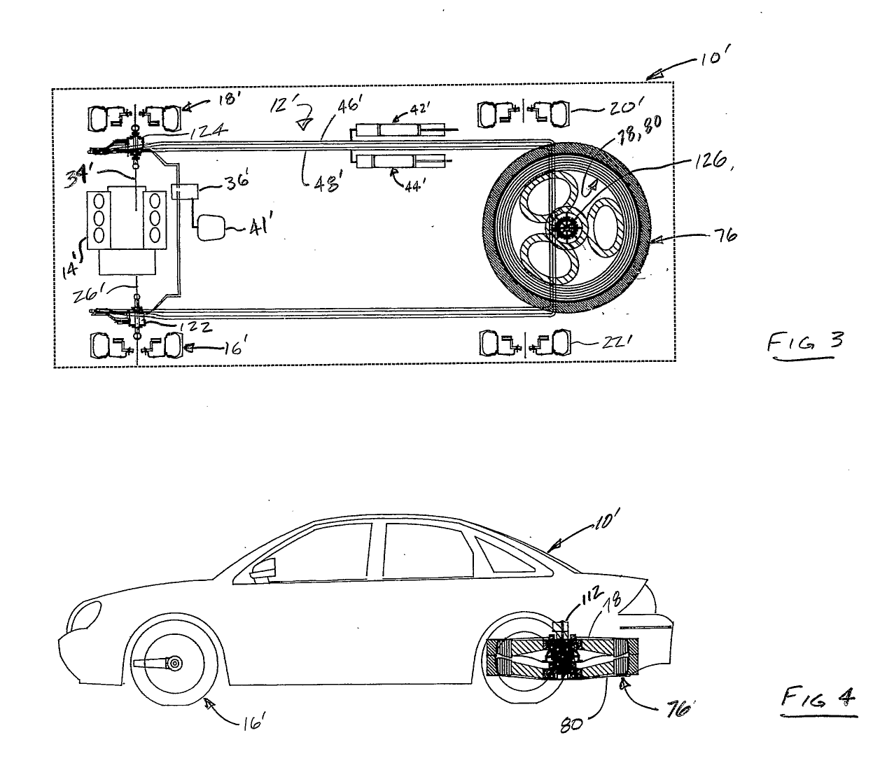

FIG. 2 shows a side view of the vehicle 10, and illustrates that the flywheel arrangement 28 is configured to rotate around a vertical axis 62. Also shown in FIG. 2 is the pump/motor 24 which cooperates with the drive wheel 16. Although the embodiment illustrated in FIGS. 1 and 2 include only two drive wheels—i.e., the drive wheels 16, 18,—other embodiments of the present invention may include more or less drive wheels. For example, one or more pump/motors could be disposed on a rear axle of a vehicle, or on a rear driveshaft, as desired.

As shown in FIG. 1, the flywheel arrangement 28 includes a flywheel 64, which is disposed inside a containment ring 66. In the embodiment shown in FIG. 1, the flywheel 64 includes an ring 68 and a hub 70. The ring 68 is disposed outside the hub 70, and can be made up of a series of concentric rings. The ring 68 and the hub 70 are connected to each other by five generally oval spokes 72. Although a flywheel, such as the flywheel 64, may be configured with generally straight spokes, the oval spokes used in the embodiment shown in FIG. 1 may provide some advantages. For example, the oval spokes 72 provide some elasticity in the radial direction, which is useful when the flywheel 64 is operating at high speeds. At high speeds, the flywheel 64 will impart a relatively large centrifugal force to the hub 70. The radial elasticity inherent in the oval spokes 72 helps to reduce the amount of centrifugal force seen by the hub 70. Moreover, despite their elasticity in a radial direction, the oval spokes 72 are generally stiff in a tangential direction, such that rotational motion of the hub 70 caused by the pump/motor 30, will be transferred to the ring 68 with minimum spoke deflection.

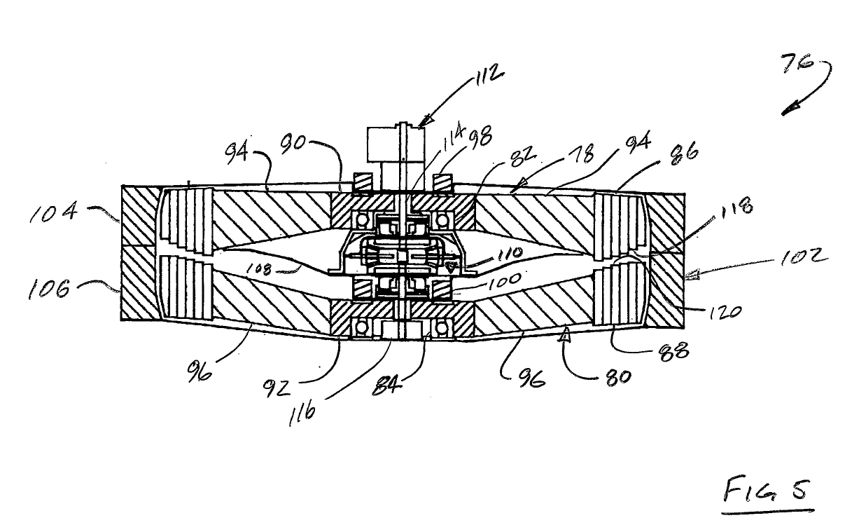

The containment ring 66 helps to insure that the flywheel 64 will be completely contained in case of a mechanical failure. Disposed above and below the flywheel 64, and cooperating with the containment ring 66, is a housing 74, shown in FIG. 2. The housing 74 can be evacuated to a relatively high vacuum, such that the flywheel 64 can rotate freely, with very little air resistance. Although a flywheel arrangement, such as the flywheel arrangement 28, may include a single flywheel, such as the flywheel 64, a flywheel arrangement in accordance with the present invention may also include more than one flywheel. Such a configuration is illustrated in FIGS. 3 and 4, where components similar to those illustrated in the embodiment shown in FIGS. 1 and 2 are designated with the same label number, but the prime (′) symbol.

In the embodiment shown in FIGS. 3 and 4, a flywheel arrangement 76 includes a pair of flywheels 78, 80 disposed in an over/under relationship with each other, which is best illustrated in FIG. 4. The two flywheels 78, 80 are configured to be counter rotating, thereby inhibiting any gyroscopic effect that may otherwise be felt during operation of the vehicle 10′. FIG. 5 shows an enlarged view of the flywheel arrangements 28′ shown in FIGS. 3 and 4. As shown in FIG. 5, the flywheels 78, 80 are respectively mounted on support structures, which, in the embodiment shown in FIG. 5, are ceramic bearings 82, 84. Each of the flywheels 78, 80 includes an ring 86, 88 connected to a respective hub 90, 92 by spokes 94, 96.

Because flywheels, such as the flywheels 78, 80, may have a relatively large mass, it may be necessary to support them on relatively heavy duty bearings. In the embodiment shown in FIG. 5, however, the ceramic bearings 82, 84 may be relatively light duty because some of the weight of the flywheels 78, 80 is carried through magnetic attraction. Specifically, the hubs 90, 92 are made from a magnetic material, and electromagnets 98, 100 are disposed above the respective hubs, 90, 92.

A containment ring 102 of the flywheel arrangement 76 is split into two pieces 104, 106. Between the two pieces 104, 106 of the containment ring 102 is a center support plate 108. The support plate 108 supports a planetary gear arrangement 110 which is also operatively connected to a hydraulic machine, or pump/motor 112. Torque output from the pump/motor 112 can be transferred to the flywheels 78, 80 through the planetary gear arrangement 110. Conversely, the flywheels 78, 80 can rotate the planetary gear arrangement 110, which in turn rotates a shaft 114 connected to the pump/motor 112, such that it is operated as a pump. In addition to the hydraulic pump/motor 112 connected to the shaft 114, a small electric machine, or generator/motor 116 is also attached to the shaft 114.

The generator/motor 116 is configured to provide torque to rotate the flywheels 78, 80 when it is connected to a source of electric power. The generator/motor 116 can also be operated as a generator, receiving energy from the flywheels 78, 80, and outputting electrical energy back to an electric grid. In this way, relatively low cost electrical energy used during off peak hours, can be converted into mechanical energy in the flywheels 78, 80, and later used to propel the vehicle 10′. Moreover, where there are many flywheel arrangements, such as the flywheel arrangement 76 in use, the mechanical energy from the various flywheel arrangements can be converted to electrical energy and output to an electric grid during times of high electric power demand, when the vehicle 10′ is parked.

In addition to the containment ring 102, which helps to contain the flywheels 78, 80 in the event of a mechanical failure, the flywheel arrangement 78 also includes a number of other safety features. For example, the spokes 94 are configured to be relatively brittle near their inner attachment at the hub 90. In this way, the spokes 94 will break away from the hub 90 in the presence of a pre-determined force, such as in the case of a vehicle collision. The upper flywheel 78 will then move downward to contact the lower flywheel 80. Keeping in mind that the two flywheels 78, 80 are counter rotating, they will act against each other to dissipate the rotational energy. This feature is further augmented by the configuration of the rings 86, 88, which, as shown in FIG. 5, includes surfaces 118, 120, facing each other. The surfaces 118, 120 are configured with steps to increase friction as the rings 86, 88 contact each other. Moreover, the surfaces 118, 120 are configured such that contact between the rings 86, 88 will first occur at an inside diameter near the spokes 94, 96, prior to contact near the containment ring 102.

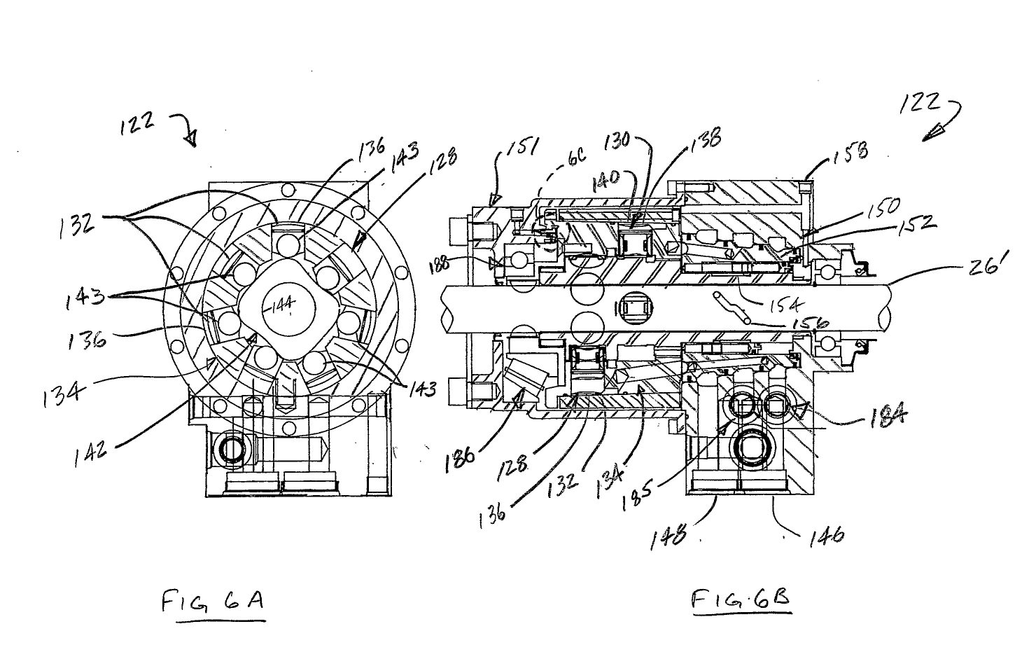

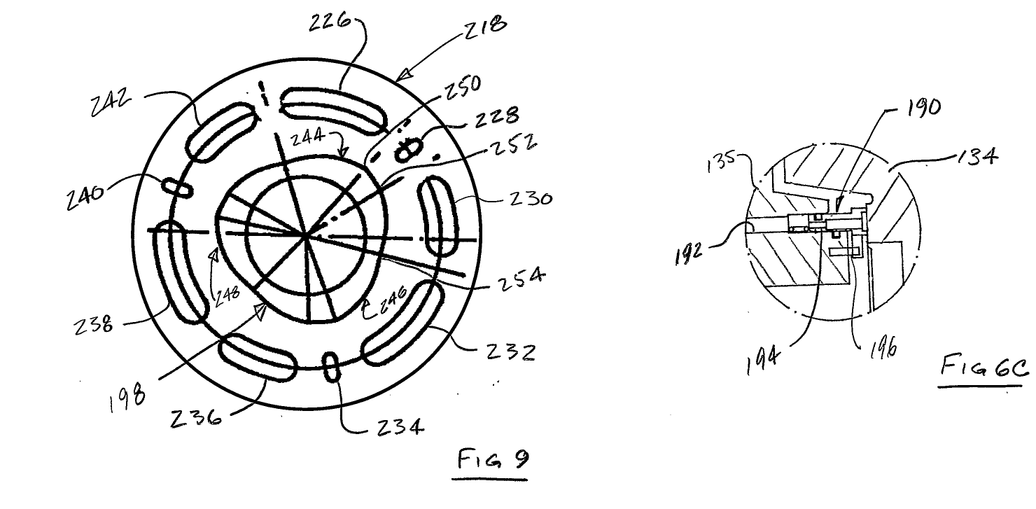

In addition to having a differently configured flywheel arrangement, the regenerative braking system 12′, shown in FIG. 3, has other differences from the regenerative braking system 12, shown in FIG. 1. For example, the system 12′, shown in FIG. 3, does not utilize a transformer, such as the transformer 38 shown in FIG. 1. Rather, the system 12′, shown in FIG. 3, uses variable displacement pump/motors 122, 124 at the vehicle drive wheels 16′, 18′, and a variable displacement pump motor 126 at the flywheel arrangement 76. In one embodiment, one or more of the variable displacement pump/motors 122, 124, 126, can be configured as a three-speed machine. Such a pump/motor is illustrated in FIGS. 6A and 6B. FIG. 6A shows a cross-sectional end view of the pump/motor 122, which is described here in detail to provide one example of a variable displacement hydraulic machine that can be used in accordance with the present invention.

FIG. 6B shows a side cross-sectional view of the pump/motor 122, which includes two banks 128, 130 of piston/cylinder combinations. As discussed above, hydraulic machines in accordance with the present invention can be configured with different numbers of piston/cylinder combinations, as desired. As shown in FIG. 6A, the first bank 128 includes seven pistons 132 radially oriented around a cylinder block 134, which has cylinders 136 disposed therein. The cylinder block 134 is keyed to the axle 26′, shown in FIG. 3. Although only one piston 138 is shown in the second bank 130 in FIG. 6B, it is understood that the second bank 130 also includes seven of the pistons 138 radially oriented around the cylinder block 134, and each of the pistons 138 travels within a corresponding cylinder 140.

The pump/motor 122 also includes a cam 142 having an aperture 144 configured to allow the axle 26′ to pass therethrough. Thus, the axle 26′ turns the cylinder block 134, while the cam 142 is stationary. Riding on the cam 142 are cam followers 143, which cooperate with the pistons 132, 138 to operate the pistons 132, 138 to pump fluid to the pump/motor 126 associated with the flywheel 76 (both shown in FIG. 3) when the pump/motor 122 is operating as a pump. Conversely, when the pump/motor 122 is operating as a motor, the flywheels 78, 80 operate the pump/motor 126 as a pump, which outputs fluid to the pump/motors 122, 124 at the front of the vehicle 10′. The fluid received by the pump/motors 122, 124 causes them to operate as motors, outputting torque to respective axles 26′, 34′.

Returning to FIG. 6B, it is shown that the pump/motor 122 includes a high pressure port 146 and a low pressure port 148 disposed within port housing 150. The high and low pressure fluid ports 146, 148 are respectively connected to the high and low pressure fluid lines 46′, 48′, shown in FIG. 3. Although FIG. 6B shows the high pressure fluid port 146 connected only to the cylinders 136 in the first bank 128, and the low pressure fluid port 148 is shown in FIG. 6B connected only to the cylinders 140 in the second bank 130, it is understood that both the high and low pressure fluid ports 146, 148 are connected to the cylinders 136, 140 in each of the banks 128, 130. Attached to the port housing 150 and surrounding the cylinder block 134 is an outer housing 151.

In order to facilitate a connection between the cylinders 136, 140 and the high and low pressure fluid ports 146, 148, the pump/motor 122 includes a valve plate 152. The valve plate 152 also remains relatively stationary, like the cam 142, while the cylinder block 134 rotates with the axle 26′. The port housing 150 and the outer housing 151 are also stationary. It is worth noting that in other embodiments, a cam and valve plate, such as the cam 142 and the valve plate 152 may be configured to rotate with the shaft, such as the axle 26′, while a respective cylinder block is stationary. In either case, the valve plate 152 is movable relative to the cam 142, which allows the pump/motor 122 to switch from a pump to a motor, and vice versa. For example, when the pump/motor 122 is operating as a pump, a cylinder 136, 140 will be connected to the high pressure fluid port 146 when a corresponding piston 132, 138 is in an outstroke. Conversely, when the pistons 132, 138 are in an instroke, their respective cylinders 136, 140 will be connected to the low pressure fluid port 148. In order to change the operation of the pump/motor 122 from a pump to a motor, the valve plate 152 is rotated relative to the cam 142, such that the fluid connections to the cylinders 136, 140 are reversed. Specifically, when the pump/motor 122 is operating as a motor, the cylinders 136, 140 will be connected to the high pressure fluid port 146 when their respective pistons 132, 138 are in an instroke, and they will be connected to the low pressure fluid port 148 when their respective pistons 132, 138 are in an outstroke.

In order to effect movement of the valve plate 152 relative to the cam 142, the pump/motor 122 includes an axial piston 154. The piston 154 drives the valve plate 152 via a link (not shown) attached to the valve plate 152 and riding in a slot 156 disposed in the axle 26′. The movement of the link in the slot 156 translates the linear movement of the axial piston 154 into rotational movement of the valve plate 152. Movement of the axial piston 154 in one direction is effected by fluid entering a mode port 158 located in the port housing 150. A spring (not shown) is provided to return the axial piston 154 to its previous position when the fluid pressure from the mode port 158 is exhausted.

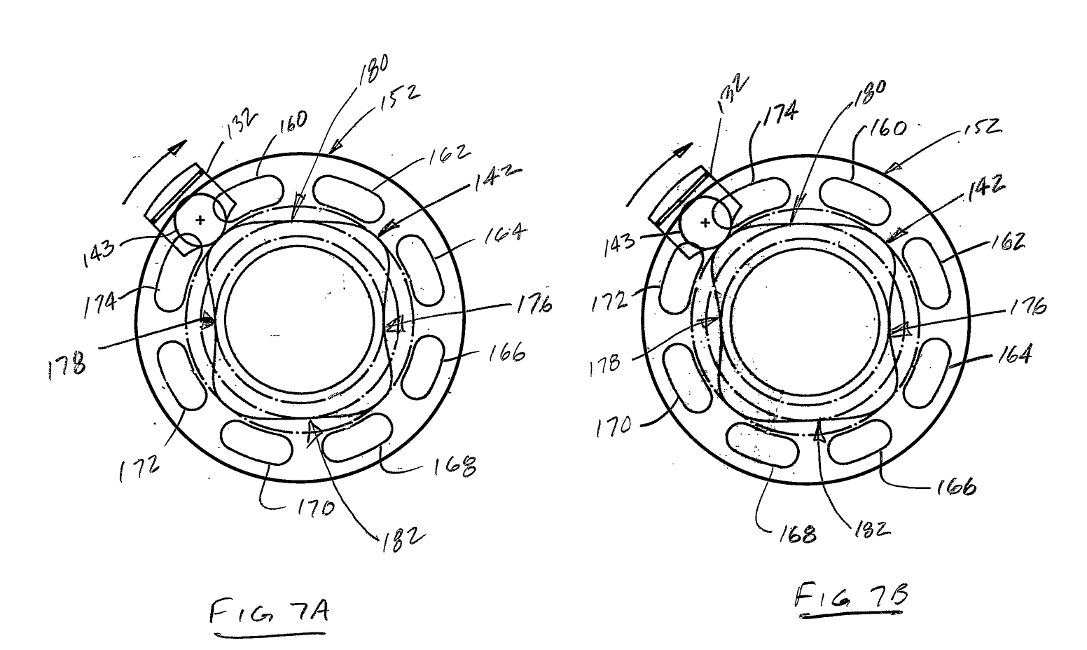

In order to the facilitate a connection between the high and low pressure ports 146, 148 and the cylinders 136, 140, the valve plate 152 includes a number of apertures or ports 160, 162, 164, 166, 168, 170, 172, 174—see FIGS. 7A and 7B. In FIG. 7A, the pump/motor 122 is operating in a motor mode. Two sets of ports 160, 168 and 164, 172 can communicate with the high or low pressure ports 146, 148 depending on the displacement required.

As shown in FIG. 7A, a piston 132 and a cam follower 143 move around the cam 142 in a clockwise direction. The cam 142 is configured with four lobes 176, 178, which are full stroke lobes, and lobes 180, 182, which are partial stroke lobes. Since the cam 142 will remain stationary relative to the valve plate 152, it is shown in FIG. 7A that the valve ports 160, 168 will communicate with cylinders 136, 140 when they move on the partial stroke lobes 180, 182. Similarly, the valve ports 164, 172 will communicate with cylinders 136, 140 when they move on the full stroke lobes 176, 178. The remaining four valve ports 162, 166, 170, 174 are connected to the low pressure port 148 continuously. As noted above, the pump/motor 122 is configured as a three-speed machine, capable of operating at three different speeds as a motor, and capable of outputting three different flow rates when operating as a pump. Continuing to use the example of the pump/motor 122 operating as a motor, as its components are shown in FIG. 7A, a change in the speed of operation can be effected by changing which of the valve ports 160-174 are connected to the high pressure port 146, and which of them are connected to the low pressure port 148. In order to effect this change, first and second control valves, such as spool/poppet valves 184, 185 are used—see FIG. 6B. It is worth noting that in the example given herein, two spool/poppet valves 184, 185 are used, though in other embodiments, greater or fewer than two can be used. As explained below, the two spool/poppet valves 184, 185, each having two positions, facilitate operation of the pump/motor 122 at three different discrete displacements/speeds. For a two displacement/speed machine, a single spool/poppet valve can be used, and for a machine operable at more than three displacements/speeds, more than two spool/poppet valves may be used.

To increase the speed of the pump/motor 122 as its components are shown in FIG. 7A, the spool/poppet valve 185 is moved to a position such that the full stroke ports 164, 172 are connected full time to the low pressure port 148. This causes the pump/motor 122 to operate with 38.2% displacement, or stated another way, when it is operating as a motor, the speed of the pump/motor 122 will be 2.62 times its operating speed at full displacement. If the spool/poppet valve 184 is moved such that the two partial stroke valve ports 160, 168 are connected to the low pressure port 148, instead of the high pressure port 146, and the spool/poppet valve 185 is positioned to connect the full stroke valve ports 164, 172 to the high pressure port 146, then the pump/motor 122 will operate with 61.8% displacement. In this situation, when the pump/motor 122 is operating as a motor, its speed will be 1.62 times the speed of a full displacement motor for a given flow rate.

To complete the example, FIG. 7B shows components of the pump/motor 122 configured for operation as a pump. In this example, the valve plate 152 has been rotated 45° clockwise as compared to its position in FIG. 7A. Also shown in FIG. 7B, the cam 142 has retained its position, such that the cam lobes 176, 178, 180, 182, are in the same position they were when the pump/motor 122 was operating as a motor. As shown in FIG. 7B, components of the pump/motor 122 are configured to facilitate operation of the pump/motor 122 with full displacement, such that the valve ports 164, 172, corresponding to full stroke cam lobes 176, 178, are connected to the high pressure port 146 as the corresponding pistons 132, 138 move between BDC and TDC. Similarly, the valve ports 160, 168 corresponding to partial stroke cam lobes 180, 182 are also connected to the high pressure port 146. When the spool/poppet valve 185 is moved to a position such that the valve ports 164, 172 are connected full time to the low pressure port 148, the pump/motor 122 will operate at 38.2% of its full displacement. Similarly, when the spool/poppet valve 184 is moved to a position such that the partial stroke valve ports 160, 168 are connected full-time to the low pressure port 148, and the spool/poppet valve 185 is positioned to connect the full stroke valve ports 164, 172 to the high pressure port 146, the pump/motor 122 will operate at 61.8% of its full displacement.

It is worth noting that two of the full-time low pressure valve plate ports 162, 170 are of substantially equal size. Conversely, the low pressure valve plate port 166 is shorter than the ports 162, 170, and the low pressure valve plate port 174 is longer than the low pressure ports 162, 170. As described above, the change from high pressure to low pressure can be made to occur so that all of the cylinders do not experience this change simultaneously. Offsets in the port spacing correspond to offsets in their respective cam lobes, and result in spacing “events” occurring individually. Although the port lengths differ, the space between them is generally uniform, thus ensuring that at least one of them will always be in communication with at least one of the cylinders 136, 140, thereby avoiding a “hydraulic lock” effect.

Although FIG. 6B is representative of the configuration of a pump/motor, such as the pump/motor 122, the cross-sectional drawing shown in FIG. 6B actually shows two different support mechanisms, which would typically not be used together, rather, one or the other would be chosen. Specifically, a tapered roller bearing 186 is shown supporting the cylinder block 134 near the bottom of the block 134 as shown in the drawing figure. The tapered roller bearing 186 is configured to handle not only radial loads, such as the load caused by the rotation of the cylinder block 134, but also thrust loads, such as the loads caused by the introduction of high pressure fluid through the high pressure fluid port 146 in the port housing 150.

Although the tapered roller bearing 186 may provide an acceptable mechanism for supporting the cylinder block 134, an alternative is also shown in FIG. 6B. Near the top of the drawing figure is a smaller ball bearing 188, configured to handle radial loads and some light thrust loads. The ball bearing 188 has a lighter duty rating as compared to the larger tapered roller bearing 186, but is less expensive and less complex, because it is not required to also handle large thrust loads. In order to support the cylinder block 134 in the face of the axial thrust loads caused by the high pressure fluid entering the port housing 150, a small balance piston 190 is used—see FIG. 6C.

As shown in FIG. 6C, high pressure fluid can be fed to the back of the piston 190 through a high pressure feed line 192. The high pressure feed line 192 has a cross-sectional area slightly smaller than the face of the piston 190. An orifice 194 in the piston 190 provides a restricted flow passage, such that there is a pressure drop in the fluid entering from the high pressure feed line 192. The pressure drop is proportional to the square of the flow velocity through the orifice 194. This allows the balance piston 190 to find a position such that the full pressure times the apply area equals the separating area times the reduced pressure. The position of the balance piston 190 is self-regulating. If leakage in the pump/motor 122 increases, the separating pressure drops, and the piston 190 moves to decrease the operating gap. Conversely, if the leakage in the pump/motor 122 decreases, the separating pressure increases, and the piston 190 moves to increase the operating gap. The design of the orifice 194 is adjusted to minimize the loss due to high pressure fluid leakage while maintaining a film of fluid between the rotating cylinder block 134 and the stationary balance piston 190. Also shown in FIG. 6C is a tab 196 mounted to the stationary housing 134, and provided to keep the piston 190 from rotating along with the cylinder block 134.

Although the pump/motor 122 described above, and illustrated in FIGS. 6A and 6B, is configured as a three-speed machine, it is also possible to provide a continuously variable pump/motor having a similar configuration to the pump/motor 122. To provide for continuously variable output, coordination between the cam lobes and the valve ports and the valve plates is required. A detailed description of such a pump/motor can be found in the previously referenced international patent application PCT/US2005/045825. In summary, the valve plate is indexed relative to the cam such that changes between high and low pressure occur in the cylinders at different points in the pistons' strokes. When the pressure changes in the cylinders occur when the pistons are at TDC and BDC, the hydraulic machine operates at full displacement. Conversely, when the valve plate is indexed relative to the cam such that the pressure changes in the cylinders occur when the pistons are at some intermediate position, the hydraulic machine operates at partial displacement. The output of the hydraulic machine can be adjusted by changing the position of the valve plate relative to the cam—i.e., changing the point in the pistons' strokes where the pressure changes occur.

It is worth noting that a multi-speed pump/motor capable of operating at discretely defined speeds, such as the three speed pump/motor 122 described above, can simultaneously be configured for continuous variable displacement. In this way, adjustments to the speed/displacement can first be made in discrete increments by appropriately positioning, for example, spool/poppet valves, and then further adjustments can be made by moving the valve plate relative to the cam. This combination of discrete and continuously variable displacement may help to reduce flow interruptions and provide an increase in efficiency as compared to a hydraulic machine that only provides continuously variable displacement,

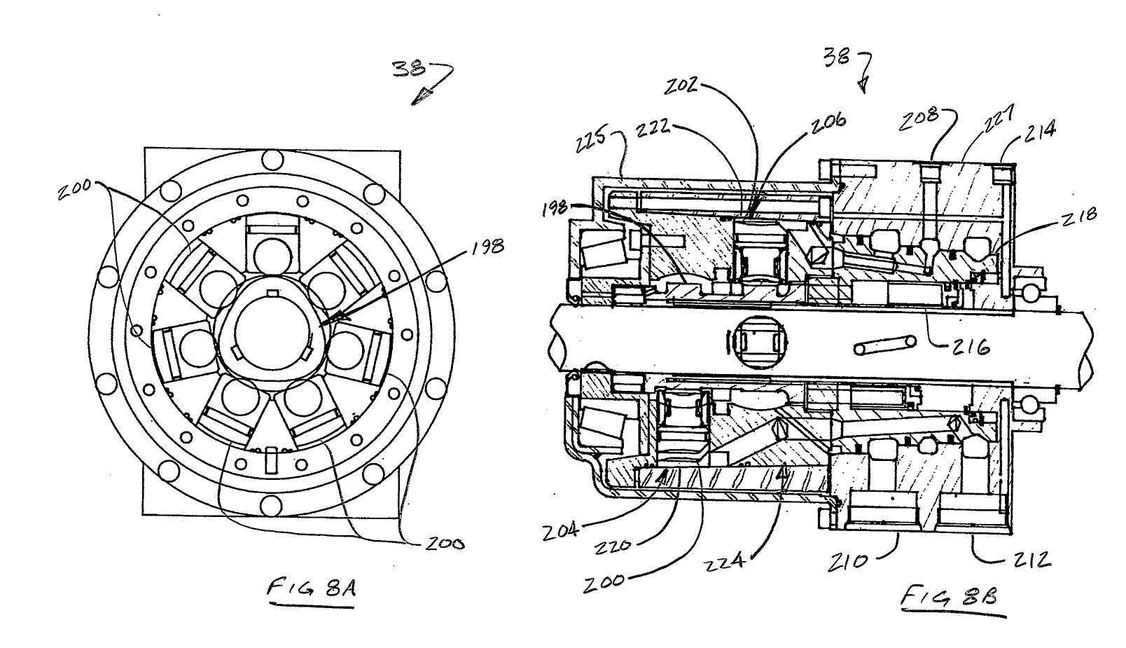

Also described above, an alternative to using variable displacement pump/motors, is to use a variable displacement hydraulic transformer, such as the transformer 38 shown in FIG. 1. The transformer 38 is shown in detail in two cross-sectional views in FIGS. 8A and 8B. The transformer 38 is configured similarly to the pump/motor 122, in that it is a radial piston device having a cam 198 disposed inboard of the pistons 200, 202 configured in two adjacent banks 204, 206, as shown in FIG. 8B. One notable difference between the transformer 38 and the pump/motor 122 described above, is that in addition to a high pressure port 208 and a low pressure port 210, the transformer 38 also has a port 212 connected to the tank 40, shown in FIG. 1. As described above, the connection to the tank 40 allows the transformer 38 to step up pressure by exhausting some of the fluid volume into the tank 40. Conversely, in a step down mode, the flow rate of the fluid going through the transformer 38 will increase as fluid is retrieved from the tank 40. Since the flow rate is inversely proportional to the pressure, the output pressure of the fluid leaving the transformer 38 will be less than the pressure of the fluid entering it.

Also shown in FIG. 8B is a fluid port 214 configured to receive fluid to control the ratio of the input to output flow for the transformer 38. Specifically, the pressure of the fluid at the ratio control port 214 is controlled by the control module 36, shown in FIG. 1. The fluid entering the ratio control fluid port 214 is used to actuate an axial piston 216, which in turn rotates a valve plate 218 to adjust the position of valve plate ports relative to piston cylinders 220, 222 disposed in a cylinder block 224. Surrounding the cylinder block 224 is an outer housing 225, which is attached to a port housing 227 containing the ports 208-214.

The valve plate 218 is shown in FIG. 9 having valve plate ports 226, 228, 230, 232, 234, 236, 238, 240, 242. Of these nine valve plate ports 226-242, three are connected to the low pressure port 210, three are connected to the high pressure port 208, and three are connected to the tank port 212. Specifically, the largest three valve plate ports 226, 232, 238 are connected to the low pressure port 210, the three smallest valve plate ports 228, 234, 240 are connected to the high pressure port 208, and the three intermediate valve plate ports 230, 236, 242 are connected to the tank port 212. Rotation of the valve plate 218 relative to the cam 198 changes the alignment of the valve plate ports 226-242 with the lobes on the cam 198. In this way, a transition between the high pressure port 208, the low pressure port 210, and the tank port 212 can be effected at any point in a corresponding piston stroke. This provides a continuous variable pressure ratio for the transformer 38.

As shown in FIG. 9, the valve plate 218 is oriented with the cam 198, which has three lobes 244, 246, 248. Each of the three lobes 244, 246, 248 corresponds to one set of three of the valve plate ports 226-242. For example, the lobe 244 corresponds to the valve plate ports 226, 228, 230. Each of the three lobes 244, 246, 248 corresponds to one low pressure valve plate port, one high pressure valve plate port, and one tank valve plate port. On each of the lobes 244, 246, 248, there are three zero velocity points that correspond to a transition between the valve plate ports. For example, on the lobe 244, the zero velocity points are 250, 252, 254. At the design pressure ratio, this allows all pressure switching between the three different ports 208, 210, 212 to be effected when the corresponding piston is momentarily stopped. If there is an adjustment to the pressure ratio, the pressure switching may occur while the corresponding piston is at some non-zero velocity.

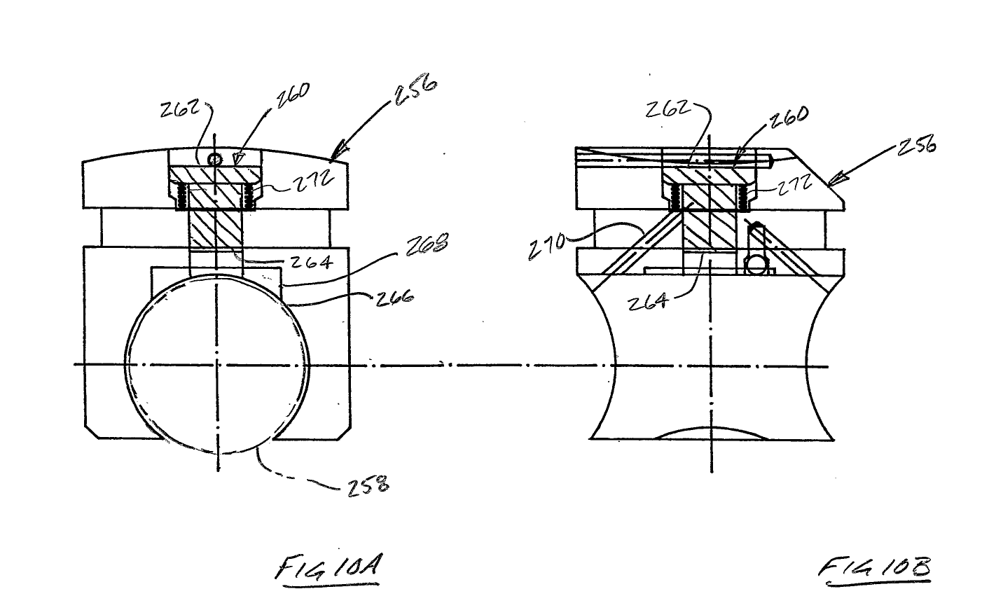

One issue that may need to be addressed with regard to the function of a radial piston hydraulic machine, is the output of an undesirably low torque when the machine is initially started. This can be a result of friction between a cam follower, and a piston head. One possible solution to this is illustrated in FIGS. 10A and 10B. A piston head 256, such as may be used in a hydraulic, pump/motor or a hydraulic transformer, as described above, is shown in FIG. 10A with a cam follower 258 shown in phantom. Disposed inside the piston head 256 is a second piston 260 which is used to help force hydraulic fluid toward the cam follower 258 to reduce friction. As shown in FIGS. 10A and 10B, an upper surface of the piston 260 has a larger area than a lower surface 264. In this way, a force exerted on the upper surface 262 will transmit a higher pressure downward toward the cam follower 258. Fluid is forced into the interface 266 between the cam follower 258 and the piston head 256.

As shown in FIG. 10A, a counterbore 268 is formed in the piston head 256 to provide a larger surface area for the hydraulic fluid. As shown in FIG. 10B, the piston head 256 also includes a vent line 270 which can allow fluid to escape from underneath the small piston 260. In addition, the small piston 260 is configured with a spring 272 which allows the piston 260 to return to a top dead center position when the fluid pressure from the top surface 262 is released.

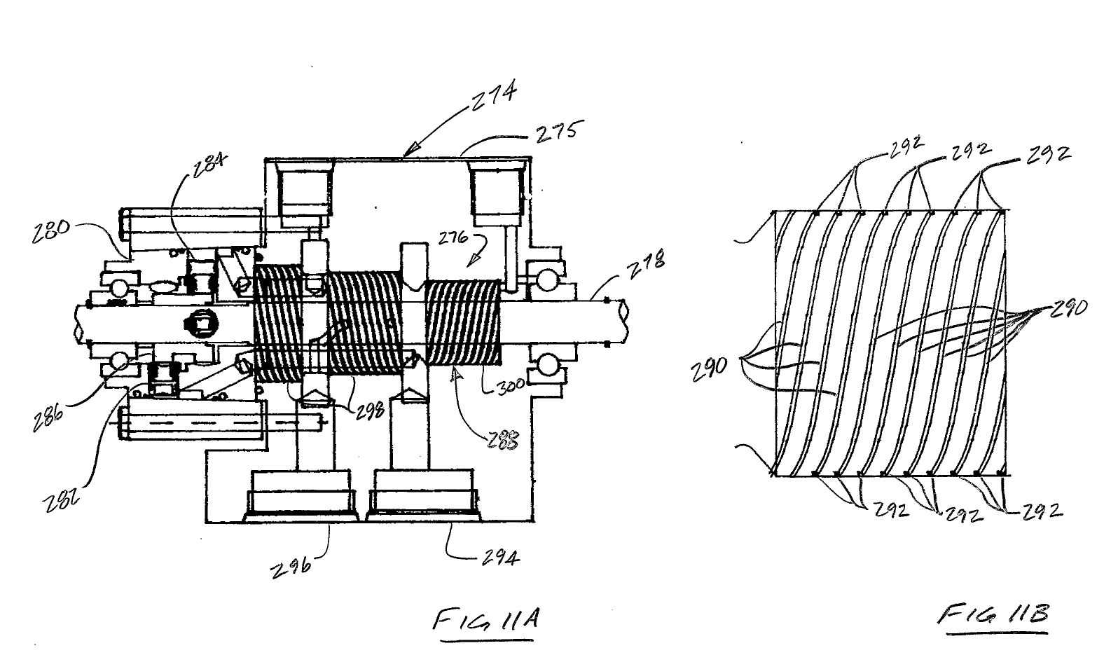

As described above, flywheels used with hydraulic systems, such as the system 12 shown in FIG. 1, and the system 12′ shown in FIG. 3, may include flywheels rotating at very high speeds. Thus, pump/motors, such as the pump/motor 30 shown in FIG. 1, and the pump/motor 126 shown in FIG. 3, may also operate at very high speeds. Because of the high centrifugal forces resulting from the high rotational speeds, it may be desirable to have the cylinder block within such a pump/motor stationary, while the respective cam and valve plate rotate. In addition, because these hydraulic machines receive or pump fluid between high speed rotating parts, providing adequate seals can present a design challenge. One solution to this problem is illustrated in FIGS. 11A and 11B. FIG. 11A shows a side cross-sectional view of a high speed pump/motor 274. The pump/motor 274 includes port housing 275 and a rotating valve plate 276 that rotates with a shaft 278. Disposed adjacent to the valve plate 276 is a cylinder block 280, which will remain stationary as the valve plate 276 and the shaft 278 rotate. In order to effect movement of pistons 282, 284 in the cylinder block 280, a cam 286 also rotates with the shaft 278. This is in contrast to the pump/motor 122 described above, which had a stationary cam and a rotating cylinder block.

The valve plate 276 is configured with a labyrinth seal 288 that includes a plurality of grooves 290 and lands 292. These are shown in greater detail in 11B, where each land 292 is followed by a groove 290. The grooves 290 are formed in the valve plate 276, although they can be formed in the shaft 278, or in both the valve plate 276 and the shaft 278. As the fluid flows from the lands 292 into the grooves 290, the grooves 290 provide a sharp increase in volume. As the fluid flows through the labyrinth seal 288, its flow velocity alternatively increases and decreases, and each transition in flow velocity acts as a sharp-edged orifice to impede the flow. As the shaft 278 and the valve plate 276 rotate, the helical grooves 290 will act to pump fluid axially within the valve plate 276. The pumping action of the fluid in the rotating helical grooves 290, or in other embodiments, rotating fluid in mating stationary grooves, can be designed to counteract the axial leakage within the labyrinth seal. One such example of a labyrinth seal used in a hydraulic pump/motor is given below. For a hydraulic pump/motor having the following parameters:

Journal Diameter=0.860 in.

Rotating Speed=40,000 RPM

Hydraulic Fluid Pressure=5,000 psi.

Radial Clearance=0.00025 in.

Axial Leak Velocity=19 ft./sec

Total Leakage=0.15 cu. in./sec., the following dimensions of a labyrinth have been found to be effective:

Groove Helix Angle=10°

Groove Width/Depth=0.0109 in.

Land Width=0.049 in.

Number of helical (thread) starts around circumference=8

Number of lands required=10.

Similar to other hydraulic machines described above, the pump/motor 274 includes a high pressure fluid port 294 and a low pressure fluid port 296. The grooves 290 disposed in the valve plate 276 include a first set 298, having a right hand orientation, and a second set 300, having a left hand orientation. This helps to guide leaked fluid back toward the high pressure port 294, regardless of which side of the port 294 the fluid is located. As noted above, this example provides just one illustration of how a labyrinth seal might be configured in a hydraulic machine, to control leakage.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A hydraulic regenerative braking system for a vehicle having at least one wheel, the system comprising:
a first hydraulic machine operable as a pump configured to be driven by energy received from the at least one wheel when the vehicle is braking, thereby facilitating storage of vehicle braking energy, the first hydraulic machine being further operable as a motor configured to be driven by stored braking energy, thereby providing torque to the at least one wheel;
a flywheel arrangement configured to receive and store at least some of the vehicle braking energy, and to provide energy to the first hydraulic machine, thereby facilitating operation of the first hydraulic machine as a motor;
a second hydraulic machine operatively attached to the flywheel arrangement and configured to receive fluid from the first hydraulic machine to operate as a motor to provide torque to the flywheel arrangement, the second hydraulic machine being further operable as a pump configured to be driven by energy received from the flywheel arrangement to pump fluid to the first hydraulic machine to facilitate operation of the first hydraulic machine as a motor; and
a control system including at least one control module, the control system being configured to receive inputs related to operation of the vehicle, and to control fluid flow through the first and second hydraulic machines.

2. The system of claim 1, wherein the control system is operatively connected to the first and second hydraulic machines to control the fluid flow therethrough, each of the first and second hydraulic machines being variable displacement machines.

3. The system of claim 2, wherein at least one of the first and second hydraulic machines includes:
a port housing including a high pressure fluid port and a low pressure fluid port,
a cylinder block in fluid communication with the port housing and including a plurality of cylinders therein,
a plurality of radial pistons, each of the pistons being configured to reciprocate within a corresponding cylinder in the cylinder block and having a corresponding piston stroke, the pistons pumping fluid when the respective hydraulic machine is operating as a pump, and providing torque when the respective hydraulic machine is operating as a motor, each of the pistons including a corresponding cam follower,
a cam disposed inboard of the pistons, and having a plurality of lobes configured to cooperate with the cam followers to translate rotational motion of the cam into linear motion of the pistons when the respective hydraulic machine is operating as a pump, and to translate linear motion of the pistons into rotational motion of the cam when the respective hydraulic machine is operating as a motor, at least one of the lobes having a first profile to effect a full-stroke movement of a corresponding piston, and at least one of the lobes having a second profile lower than the first profile to effect a partial-stroke movement of a corresponding piston,
a valve plate including a plurality of apertures therethrough, at least one of the apertures communicating with the high pressure fluid port and at least one other of the apertures communicating with the low pressure fluid port, the valve plate being configured to connect at least one of the cylinders with the high pressure fluid port and at least one other of the cylinders with the low pressure fluid port,
a first control valve movable between first and second positions, the first position of the first control valve facilitating fluid flow between the high pressure port and at least one cylinder having a corresponding piston operating at a full stroke lobe on the cam, the second position of the first control valve facilitating fluid flow between the low pressure port and at least one cylinder having a corresponding piston operating at a full stroke lobe on the cam, and
a second control valve movable between first and second positions, the first position of the second control valve facilitating fluid flow between the high pressure port and at least one cylinder having a corresponding piston operating at a partial stroke lobe on the cam, the second position of the second control valve facilitating fluid flow between the low pressure port and at least one cylinder having a corresponding piston operating at a partial stroke lobe on the cam, movement of at least one of the first or second control valves between its respective first and second positions effecting discrete variation in the displacement of the hydraulic machine.

4. The system of claim 2, wherein at least one of the first and second hydraulic machines includes:
a port housing including a high pressure fluid port and a low pressure fluid port,
a cylinder block in fluid communication with the port housing and including a plurality of cylinders therein,
a plurality of radial pistons, each of the pistons being configured to reciprocate within a corresponding cylinder in the cylinder block and having a corresponding piston stroke, the pistons pumping fluid when the respective hydraulic machine is operating as a pump, and providing torque when the respective hydraulic machine is operating as a motor, each of the pistons including a corresponding cam follower,
a cam disposed inboard of the pistons, and having a plurality of lobes configured to cooperate with the cam followers to translate rotational motion of the cam into linear motion of the pistons when the respective hydraulic machine is operating as a pump, and to translate linear motion of the pistons into rotational motion of the cam when the respective hydraulic machine is operating as a motor, and
a valve plate including a plurality of apertures therethrough, at least one of the apertures communicating with the high pressure fluid port and at least one other of the apertures communicating with the low pressure fluid port, the valve plate being configured to connect at least one of the cylinders with the high pressure fluid port and at least one other of the cylinders with the low pressure fluid port, the valve plate being movable relative to the housing to effect a first transition to disconnect the at least one cylinder from the high pressure fluid port and connect it with the low pressure fluid port, and to effect a second transition to disconnect the at least one other cylinder from the low pressure fluid port and connect it with the high pressure fluid port, the valve plate being movable such that the first and second transitions can be effected at a plurality of piston positions within a corresponding piston stroke, thereby facilitating variable displacement operation of the respective hydraulic machine.

5. The system of claim 4, wherein each of the pistons includes a corresponding piston head, each of the piston heads including a respective secondary piston at least partially disposed therein, each of the secondary pistons being configured to force fluid toward a corresponding cam follower to at least temporarily reduce friction between the cam follower and the piston.

6. The system of claim 4, the vehicle including a shaft connected to the at least one wheel, the system further comprising an outer housing at least partially surrounding the cylinder block, and
wherein the first hydraulic machine is operatively connected to the shaft such that the first hydraulic machine is driven by the shaft when it is operating as a pump, and the first hydraulic machine drives the shaft when it is operating as a motor, the cylinder block being configured to rotate with the shaft while the cam and valve plate remain generally stationary, thereby effecting radial movement of the pistons.

7. The system of claim 4, wherein the at least one of the first and second hydraulic machines further includes:
an outer housing at least partially surrounding the cylinder block, and
a balance piston at least partially disposed within the outer housing and configured to apply a force to the cylinder block to substantially balance an opposite force to the cylinder block applied by fluid entering the cylinder block through the high pressure port in the port housing.

8. The system of claim 4, the vehicle including a shaft connected to the at least one wheel, the system further comprising an outer housing at least partially surrounding the cylinder block, and
wherein the first hydraulic machine is operatively connected to the shaft such that the first hydraulic machine is driven by the shaft when it is operating as a pump, and the first hydraulic machine drives the shaft when it is operating as a motor, the cam and the valve plate being configured to rotate with the shaft while the cylinder block remains generally stationary, thereby effecting radial movement of the pistons.

9. The system of claim 8, further comprising a labyrinth seal disposed between the shaft and the port housing, the labyrinth seal including a plurality of helical grooves formed in at least one of the port housing or the shaft.

10. The system of claim 1, further comprising a hydraulic transformer arrangement, including a variable ratio transformer in communication with the control system and the first and second hydraulic machines, the transformer being operable to vary the pressure of the pressurized fluid provided to the first and second hydraulic machine, thereby facilitating variation in the torque provided to the at least one vehicle wheel by the first hydraulic machine and variation in the torque provided to the flywheel arrangement by the second hydraulic machine.

11. The system of claim 10, wherein the transformer arrangement includes a sump tank configured to receive fluid from the transformer when the transformer is operating in a step-up mode to increase output pressure of the fluid, the sump tank being further configured to provide fluid for retrieval by the transformer when the transformer is operating in a step-down mode to decrease the output pressure of the fluid.

12. The system of claim 1, further comprising an electric machine operatively connected to the flywheel arrangement and configured to receive electrical energy and to provide torque to the flywheel arrangement.

13. The system of claim 12, wherein the electric machine is further configured to receive torque from the flywheel arrangement and to provide electrical energy as an output.

14. The system of claim 1, wherein the flywheel arrangement includes two counter-rotating flywheels disposed in an over-under relationship to each other, a stationary containment ring disposed at least partially around the flywheels, and a containment housing configured to be evacuated to form at least a partial vacuum, thereby inhibiting air drag on the flywheels.

15. The system of claim 14, wherein the upper flywheel includes a center plate connected to a ring by a plurality of spokes, each of the spokes being configured to detach from the ring in the presence of a predetermined force, thereby removing support for the upper flywheel such that at least a portion of the upper flywheel moves downward to contact the lower flywheel to inhibit the rotational movement of both of the flywheels.

16. The system of claim 14, wherein each of the flywheels includes magnetic material, and the flywheel arrangement further includes a respective support structure disposed proximate each of the flywheels, and two magnets, each of which is disposed proximate a respective one of the flywheels, to attract or repel the respective flywheel, thereby reducing the force on the respective support structure.

17. The system of claim 1, further comprising:
a high pressure fluid line and a low pressure fluid line, each of which provides fluid communication between the first and second hydraulic machines;
a first accumulator in fluid communication with the high pressure fluid line and configured to receive and store fluid under pressure, and to provide pressurized fluid to the hydraulic machines; and
a second accumulator in fluid communication with the low pressure fluid line and configured to receive and store fluid under pressure, and to provide pressurized fluid to the hydraulic machines, each of the first and second accumulators including a gas-filled bladder and an actuator configured to apply pressure to the bladders.

18. A hydraulic regenerative braking system for a vehicle including a hydraulic machine, the system comprising:
a hydraulic transformer arrangement, including a tank in communication with a variable ratio transformer, the transformer being in communication with the hydraulic machine and configured for modifying at least one of a pressure or flow rate of fluid flowing through the transformer and to or from the hydraulic machine, the transformer including:
port housing including a high pressure fluid port and a low pressure fluid port, each of which is in communication with the hydraulic machine, the port housing further including a port in communication with the tank, each of the ports being configured to operate as a fluid inlet or as a fluid outlet;
a cylinder block in fluid communication with the port housing and including a plurality of cylinders therein;
a plurality of radial pistons, each of the pistons being configured to reciprocate within a corresponding cylinder in the cylinder block and having a corresponding piston stroke, the pistons pumping fluid when the hydraulic machine is operating as a pump, and providing torque when the hydraulic machine is operating as a motor, each of the pistons including a corresponding cam follower,
a cam disposed inboard of the pistons, and having a plurality of lobes configured to cooperate with the cam followers to translate relative rotational motion of the cam into linear motion of the pistons when the hydraulic machine is operating as a pump, and to translate linear motion of the pistons into relative rotational motion of the cam when the hydraulic machine is operating as a motor, and
a valve plate including a plurality of apertures therethrough, at least one of the apertures communicating with the high pressure fluid port and at least one other of the apertures communicating with the low pressure fluid port, the valve plate being configured to connect at least one of the cylinders with the high pressure fluid port and at least one other of the cylinders with the low pressure fluid port, the valve plate being movable relative to the port housing and the cylinder block to effect a first transition to disconnect the at least one cylinder from the high pressure fluid port and connect it with the low pressure fluid port, and to effect a second transition to disconnect the at least one other cylinder from the low pressure fluid port and connect it with the high pressure fluid port, the valve plate being movable such that the first and second transitions can be effected at a plurality of piston positions within a corresponding piston stroke, thereby facilitating variable fluid flow output from the transformer.

19. A hydraulic regenerative braking system for a vehicle having at least one wheel, the system comprising:
a hydraulic machine operable as a pump configured to be driven by energy received from the at least one wheel when the vehicle is braking, thereby facilitating storage of vehicle braking energy, the hydraulic machine being further operable as a motor configured to be driven by stored braking energy, thereby providing torque to the at least one wheel, the hydraulic machine including:
port housing including a high pressure fluid port and a low pressure fluid port,
a cylinder block in fluid communication with the port housing and including a plurality of cylinders therein,
a plurality of radial pistons, each of the pistons being configured to reciprocate within a corresponding cylinder in the cylinder block and having a corresponding piston stroke, the pistons pumping fluid when the hydraulic machine is operating as a pump, and providing torque when the hydraulic machine is operating as a motor, each of the pistons including a corresponding cam follower and a corresponding piston head, each of the piston heads including a respective secondary piston at least partially disposed therein, each of the secondary pistons being configured to force fluid toward a corresponding cam follower to at least temporarily reduce friction between the cam follower and the piston,
a cam disposed inboard of the pistons, and having a plurality of lobes configured to cooperate with the cam followers to translate relative rotational motion of the cam into linear motion of the pistons when the hydraulic machine is operating as a pump, and to translate linear motion of the pistons into relative rotational motion of the cam when the hydraulic machine is operating as a motor, and
a valve plate including a plurality of apertures therethrough, at least one of the apertures communicating with the high pressure fluid port and at least one other of the apertures communicating with the low pressure fluid port, the valve plate being configured to connect at least one of the cylinders with the high pressure fluid port and at least one other of the cylinders with the low pressure fluid port, the valve plate being movable relative to the port housing and the cylinder block to effect a first transition to disconnect the at least one cylinder from the high pressure fluid port and connect it with the low pressure fluid port, and to effect a second transition to disconnect the at least one other cylinder from the low pressure fluid port and connect it with the high pressure fluid port.

20. A hydraulic regenerative braking system for a vehicle, the vehicle including a wheel and a hydraulic machine operable as a pump configured to be driven by energy received from the wheel, and further operable as a motor configured to provide energy to the wheel, the system comprising:
a flywheel arrangement configured to receive and store at least some of the energy from the wheel, and to provide energy to the hydraulic machine, thereby facilitating operation of the hydraulic machine as a motor, the flywheel arrangement including:
a rotatable flywheel, a stationary containment ring disposed at least partially around the flywheels, and a containment housing configured to be evacuated to form at least a partial vacuum, thereby inhibiting air drag on the flywheels.

21. The system of claim 20, wherein the flywheel arrangement includes two of the rotatable flywheels configured to be counter-rotating and disposed in an over-under relationship to each other, the upper flywheel including a center plate connected to a ring by a plurality of spokes, each of the spokes being configured to detach from the ring in the presence of a predetermined force, thereby removing support for the upper flywheel such that at least a portion of the upper flywheel moves downward to contact the lower flywheel to inhibit the rotational movement of both of the flywheels.

22. The system of claim 21, wherein at least some of the spokes are generally oval.

23. The system of claim 20, wherein each of the flywheels includes magnetic material, and the flywheel arrangement further includes a respective support structure disposed below each of the flywheels, and two magnets, each of which is disposed proximate a respective one of the flywheels, thereby reducing the force on the respective support structure.

24. A hydraulic regenerative braking system for a vehicle having at least one wheel, the system comprising:
a hydraulic machine operable as a pump configured to be driven by energy received from the at least one wheel when the vehicle is braking, thereby facilitating storage of vehicle braking energy, the hydraulic machine being further operable as a motor configured to be driven by stored braking energy, thereby providing torque to the at least one wheel, the hydraulic machine including:
a port housing including a high pressure fluid port and a low pressure fluid port,
a cylinder block in fluid communication with the port housing and including a plurality of cylinders therein,
an outer housing at least partially surrounding the cylinder block,
a balance piston at least partially disposed within the outer housing and configured to apply a force to the cylinder block to substantially balance an opposite force to the cylinder block applied by fluid entering the cylinder block through the high pressure port in the port housing,
a plurality of radial pistons, each of the pistons being configured to reciprocate within a corresponding cylinder in the cylinder block and having a corresponding piston stroke, the pistons pumping fluid when the hydraulic machine is operating as a pump, and providing torque when the hydraulic machine is operating as a motor, each of the pistons including a corresponding cam follower,
a cam disposed inboard of the pistons, and having a plurality of lobes configured to cooperate with the cam followers to translate relative rotational motion of the cam into linear motion of the pistons when the hydraulic machine is operating as a pump, and to translate linear motion of the pistons into relative rotational motion of the cam when the hydraulic machine is operating as a motor, and
a valve plate including a plurality of apertures therethrough, at least one of the apertures communicating with the high pressure fluid port and at least one other of the apertures communicating with the low pressure fluid port, the valve plate being configured to connect at least one of the cylinders with the high pressure fluid port and at least one other of the cylinders with the low pressure fluid port, the valve plate being movable relative to the port housing and the cylinder block to effect a first transition to disconnect the at least one cylinder from the high pressure fluid port and connect it with the low pressure fluid port, and to effect a second transition to disconnect the at least one other cylinder from the low pressure fluid port and connect it with the high pressure fluid port.

25. A hydraulic regenerative braking system for a vehicle having at least one wheel, the system comprising:
a hydraulic machine operable as a pump configured to be driven by energy received from the at least one wheel when the vehicle is braking, thereby facilitating storage of vehicle braking energy, the hydraulic machine being further operable as a motor configured to be driven by stored braking energy, thereby providing torque to the at least one wheel, the hydraulic machine including:
a port housing including a high pressure fluid port and a low pressure fluid port,
a cylinder block in fluid communication with the port housing and including a plurality of cylinders therein,
a plurality of radial pistons, each of the pistons being configured to reciprocate within a corresponding cylinder in the cylinder block and having a corresponding piston stroke, the pistons pumping fluid when the hydraulic machine is operating as a pump, and providing torque when the hydraulic machine is operating as a motor, each of the pistons including a corresponding cam follower,
a cam disposed inboard of the pistons, and having a plurality of lobes configured to cooperate with the cam followers to translate rotational motion of the cam into linear motion of the pistons when the hydraulic machine is operating as a pump, and to translate linear motion of the pistons into rotational motion of the cam when the hydraulic machine is operating as a motor, at least one of the lobes having a first profile to effect a full-stroke movement of a corresponding piston, and at least one of the lobes having a second profile lower than the first profile to effect a partial stroke movement of a corresponding piston,
a valve plate including a plurality of apertures therethrough, at least one of the apertures communicating with the high pressure fluid port and at least one other of the apertures communicating with the low pressure fluid port, the valve plate being configured to connect at least one of the cylinders with the high pressure fluid port and at least one other of the cylinders with the low pressure fluid port, the valve plate being movable relative to the housing to effect a first transition to disconnect the at least one cylinder from the high pressure fluid port and connect it with the low pressure fluid port, and to effect a second transition to disconnect the at least one other cylinder from the low pressure fluid port and connect it with the high pressure fluid port, the valve plate being movable relative to the cam such that the first and second transitions can be effected at a plurality of piston positions within a corresponding piston stroke, thereby facilitating continuous variable displacement operation of the hydraulic machine,
a first control valve movable between first and second positions, the first position of the first control valve facilitating fluid flow between the high pressure port and at least one cylinder having a corresponding piston operating at a full stroke lobe on the cam, the second position of the first control valve facilitating fluid flow between the low pressure port and at least one cylinder having a corresponding piston operating at a full stroke lobe on the cam, and
a second control valve movable between first and second positions, the first position of the second control valve facilitating fluid flow between the high pressure port and at least one cylinder having a corresponding piston operating at a partial stroke lobe on the cam, the second position of the second control valve facilitating fluid flow between the low pressure port and at least one cylinder having a corresponding piston operating at a partial stroke lobe on the cam, movement of at least one of the first or second control valves between its respective first and second positions effecting discrete variation in the displacement of the hydraulic machine.

26. A hydraulic machine comprising:
a port housing including a high pressure fluid port and a low pressure fluid port;
a cylinder block in fluid communication with the port housing and including a plurality of cylinders therein;
a plurality of radial pistons, each of the pistons being configured to reciprocate within a corresponding cylinder in the cylinder block and having a corresponding piston stroke, the pistons pumping fluid if the hydraulic machine is operating as a pump, and providing torque if the hydraulic machine is operating as a motor, each of the pistons including a corresponding cam follower;
a cam disposed inboard of the pistons, and having a plurality of lobes configured to cooperate with the cam followers to translate rotational motion of the cam into linear motion of the pistons if the hydraulic machine is operating as a pump, and to translate linear motion of the pistons into rotational motion of the cam if the hydraulic machine is operating as a motor, at least one of the lobes having a first profile to effect a full stroke movement of a corresponding piston, and at least one of the lobes having a second profile lower than the first profile to effect a partial stroke movement of a corresponding piston;
a valve plate including a plurality of apertures therethrough, at least one of the apertures communicating with the high pressure fluid port and at least one other of the apertures communicating with the low pressure fluid port, the valve plate being configured to connect at least one of the cylinders with the high pressure fluid port and at least one other of the cylinders with the low pressure fluid port: and
a control valve movable between a first position for facilitating fluid flow between the high pressure port and at least one cylinder, and a second position for facilitating fluid flow between the low pressure port and the at least one cylinder, operation of the hydraulic machine with the control valve in the second position effecting a reduction in displacement if the hydraulic machine is operating as a pump, and effecting an increase in speed if the hydraulic machine is operating as a motor.

27. The hydraulic machine of claim 26, wherein the valve is a first valve, and the at least one cylinder has a corresponding piston operating at a full stroke lobe on the cam, the hydraulic machine further comprising:
a second control valve movable between first and second positions, the first position of the second control valve facilitating fluid flow between the high pressure port and at least one cylinder having a corresponding piston operating at a partial stroke lobe on the cam, the second position of the second control valve facilitating fluid flow between the low pressure port and the at least one cylinder having a corresponding piston operating at a partial stroke lobe on the cam,
operation of the hydraulic machine with both control valves in the first position effecting operation of the hydraulic machine at a first displacement if the hydraulic machine is operating as a pump, and at a first speed if the hydraulic machine is operating as a motor,
operation of the hydraulic machine with the first valve in the first position and the second valve in the second position effecting operation of the hydraulic machine at a second displacement less than the first displacement if the hydraulic machine is operating as a pump, and at a second speed greater than the first speed if the hydraulic machine is operating as a motor, and
operation of the hydraulic machine with the first valve in the second position and the second valve in the first position effecting operation of the hydraulic machine at a third displacement less than the second displacement if the hydraulic machine is operating as a pump, and at a third speed greater than the second speed if the hydraulic machine is operating as a motor.

28. The hydraulic machine of claim 26, further comprising:
an outer housing at least partially surrounding the cylinder block; and
a balance piston at least partially disposed within the outer housing and configured to apply a force to the cylinder block to substantially balance an opposite force to the cylinder block applied by fluid entering the cylinder block through the high pressure port in the port housing.

29. The hydraulic machine of claim 26, wherein each of the pistons further includes a corresponding piston head, each of the piston heads including a respective secondary piston at least partially disposed therein, each of the secondary pistons being configured to force fluid toward a corresponding cam follower to at least temporarily reduce friction between the cam follower and the piston.
